(19) United States
(12) Patent Application Publication
(10) Pub. No.: US 2025/0384893 A1
(43) Pub. Date: Dec. 18, 2025

(54) DEVICE AND METHOD OF CONTROLLING AUDIO TIME STRETCHING FOR DETERMINING COMPRESSION RATE BASED ON CLUSTER

(71) Applicants: IUCF-HYU (INDUSTRY-UNIVERSITY COOPERATION FOUNDATION HANYANG UNIVERSITY), Seoul (KR); AIDIO INC., Seoul (KR)

(72) Inventors: Joon Hyouk JANG, Seoul (KR); So Hee JANG, Seoul (KR); Ji Ye KIM, Seoul (KR); Yeon Ju KIM, Seoul (KR); Tae Jin MOON, Seoul (KR); Dae Gil KANG, Seoul (KR); Hwa Jin LEE, Seoul (KR); Young Duck BACK, Seongnam-si, Gyeonggi-do (KR)

(21) Appl. No.: 19/302,763

(22) Filed: Aug. 18, 2025

Related U.S. Application Data
(63) Continuation of application No. PCT/KR2023/012687, filed on Aug. 25, 2023.

(30) Foreign Application Priority Data
Feb. 20, 2023 (KR) 10-2023-0022147

(51) Int. Cl. G10L 21/057; G10L 15/187; G10L 21/043; G10L 25/21; G10L 25/78

(52) U.S. Cl. CPC G10L 21/057; G10L 15/187; G10L 21/043; G10L 25/21; G10L 25/78

(57) ABSTRACT

A device for controlling audio time stretching includes a silence interval unit configured to detect a silence interval of an audio, a cluster unit configured to classify at least one of frames except the detected silence interval of the audio to plural clusters and a script unit configured to set compression rate to the clusters and generate a speed script including information concerning the clusters with the set compression rate. Here, one or more of the clusters have different compression rate from another cluster.

### CROSS-REFERENCE TO RELATED APPLICATIONS

This application is a bypass continuation of pending PCT International Application No. PCT/KR2023/012687, which was filed on Aug. 25, 2023, and which claims priority from Korean Patent Application No. 10-2023-0022147 filed on Feb. 20, 2023. The entire contents of the aforementioned patent applications are incorporated herein by reference.

### TECHNICAL FIELD

The present disclosure relates to a device and a method of controlling audio time stretching for determining compression rate based on a cluster.

### BACKGROUND ART

An audio time stretching controls only tempo with maintaining the other features. Conventional technique controls speed using fixed window, and thus the same compression rate is applied to every speech signal irrespective of pronunciation features. As a result, distortion of the speech signal (audio) may be occurred when the speech signal is played.

### SUMMARY

The present disclosure is to provide a device and a method of controlling audio time stretching for determining compression rate based on a cluster to minimize the distortion during playback.

A device for controlling audio time stretching according to an embodiment of the disclosure includes a silence interval unit configured to detect a silence interval of an audio; a cluster unit configured to classify at least one of frames except the detected silence interval of the audio to plural clusters; and a script unit configured to set compression rate to the clusters and generate a speed script including information concerning the clusters with the set compression rate. Here, one or more of the clusters have different compression rate from another cluster.

A device for controlling audio time stretching according to another embodiment of the disclosure includes a silence interval unit configured to detect a silence interval of an audio; a cluster unit configured to classify phonemes in frames except the detected silence interval of the audio to plural clusters; and a script unit configured to set compression rate to the clusters and generate a speed script including information concerning the clusters with the set compression rate. Here, one or more of the clusters have different compression rate from another cluster, and nasal sound or fricative sound and plosive sound are assigned to different cluster.

A method of controlling audio time stretching according to an embodiment of the disclosure includes detecting a silence interval from inputted audio; classifying frames except the detected silence interval of the inputted audio to plural clusters; setting compression rate to each cluster; generating a speed script including information concerning the clusters with the set compression rate; and playing back the audio according to the generated speed script. Here, at least one of the clusters has different compression rate from another cluster.

A device and a method of controlling audio time stretching of the present disclosure classify audio into plural clusters in a unit of a frame and apply different compression rate to each cluster, thereby minimizing the distortion of a speech signal during playback.

### BRIEF DESCRIPTION OF DRAWINGS

Example embodiments of the present the present disclosure will become more apparent by describing in detail example embodiments of the present the present disclosure with reference to the accompanying drawings, in which:

FIG. 1 is a view illustrating a process of controlling audio time stretching according to an embodiment of the disclosure;

FIG. 2 is a view illustrating an example of clustering result according to an embodiment of the disclosure;

FIG. 3 is a view illustrating an example of speed script according to an embodiment of the disclosure;

FIG. 4 is a view illustrating a process of controlling audio time stretching according to another embodiment of the disclosure; and

FIG. 5 is a block diagram illustrating a device of controlling audio time stretching according to an embodiment of the disclosure.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

The disclosure relates to a device and a method of controlling audio time stretching and applying differently speed depending on pronunciation feature during the time stretching, thereby reducing distortion and outputting speech with desired length.

In an embodiment, the device and the method of controlling the audio time stretching may classify sound, e.g. speech in a frame to plural clusters and output low-distortion speech by applying different speed to each cluster.

For example, when playing back the audio at 2× speed, a pronunciation belonging to a first cluster of the speech may be played at 2.2× speed, a pronunciation belonging to a second cluster of the speech may be played at 1.8× speed, and a pronunciation belonging to a third cluster of the speech may be played at 2× speed.

Since nasal sounds such as ‘ [symbol] ’ and ‘ [symbol] ’ tend to become muffled during playback and fricative sounds such as ‘ [symbol] ’ and ‘ [symbol] ’ are more susceptible to distortion, clusters corresponding to nasal and fricative sounds may either have no speed adjustment applied or be played back at a reduced speed. In contrast, plosive sounds such as ‘ [symbol] ’ and ‘ [symbol] ’ are less prone to distortion even when speed adjustment is applied, and thus clusters corresponding to plosive sounds may be played back at a higher speed. As a result, smoother speech output can be achieved. Here, the pronunciation included in each cluster may correspond to a phoneme or a part of the phoneme. Of course, this method of controlling audio time stretching is also applicable to languages other than Korean, such as English.

In another embodiment, a silence interval, in which no speech is uttered between speeches, may be played back at an increased speed, thereby allowing the overall speech to be played at a relatively slower speed. In this case, the overall playback duration may be adjusted by controlling the playback speed of the silence intervals.

Hereinafter, various embodiments of the present disclosure will be described in detail with reference to accompanying drawings.

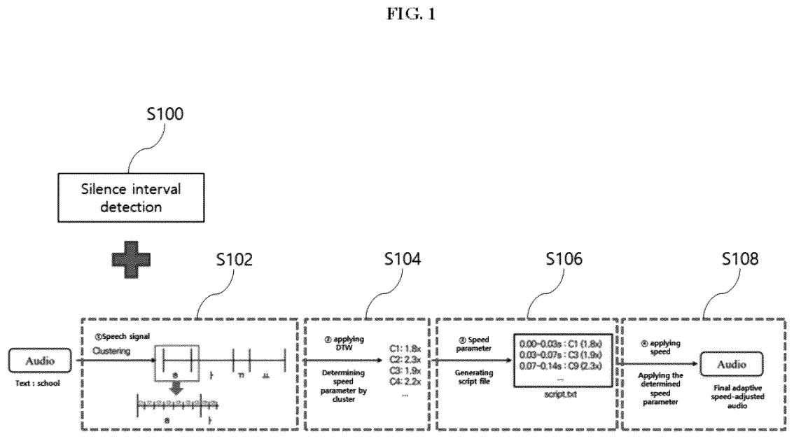

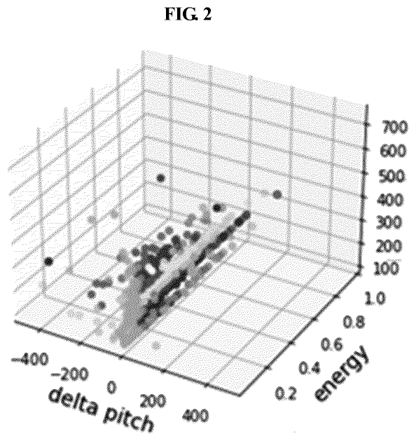

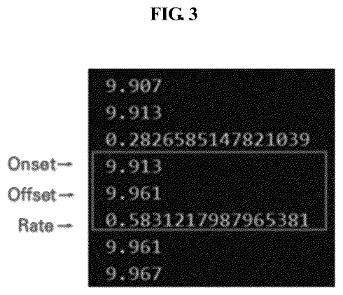

FIG. 1 is a view illustrating a process of controlling audio time stretching according to an embodiment of the disclosure, FIG. 2 is a view illustrating an example of clustering result according to an embodiment of the disclosure, and FIG. 3 is a view illustrating an example of speed script according to an embodiment of the disclosure.

In FIG. 1, a method of controlling audio time stretching of the present embodiment may output naturally speech without distortion during the audio time stretching. To realize this control, the method may detect a silence interval in which no speech is uttered of inputted audio in a step of S100. Here, the silence interval means an interval between speeches (texts). Rapid speed is applied to the silence interval, and so speed of the speech may be relatively reduced because overall audio has constant length. As a result, the distortion of the speech may be reduced.

In an embodiment, the silence interval may be detected by using information of the inputted audio. For example, the silence interval may be detected through speech feature in the inputted audio.

The speech feature may include energy, pitch, delta-pitch, mel spectrogram and Mel-frequency cepstral coefficient (MFCC). This speech feature may be extracted by using parameters in following Table 1.

TABLE 1

| parameter | value | |
|---|---|---|
| Frame length | 0.01 | sec |
| Hop size | 0.005 | sec |
| Pitch min | 65 | Hz |
| Pitch max | 400 | Hz |

In an embodiment, the silence interval may be detected by using the energy of the speech feature. For example, it is assumed that the first and/or last ten frames of the inputted audio may be silence intervals, to detect the silence intervals. Threshold may be set based on total energy for corresponding silence interval (Signal-to-noise ratio, SNR) as shown in following equation 1 and equation 2.

$$SNR = 10 * log \frac{S}{N} \qquad [ Equation 1 ]$$

Here, S means total average energy of the audio, and N indicates average energy for corresponding silence interval.

$$threshold = SNR * α \qquad [ Equation 2 ]$$

$$α = 0.65 ( hyperparameter )$$

The silence interval may be detected based on the set threshold. For example, an interval of which SNR is less than the threshold may be determined as the silence interval.

Of course, the method of detecting the silence interval may not be limited, and it may be variously modified. For example, the silence interval may be recorded to the inputted audio.

In a step of S102, the method of controlling audio time stretching may perform clustering classification about every frame except the silence interval of the audio. For example, the method may classify each of frames to nine clusters by using a K-means clustering.

For example, the method may classify “ [symbol] ” to nine clusters when “ [symbol] ” is included in a frame as shown in FIG. 1. In this case, the “ [symbol] ” may be clustered in a unit smaller than a phoneme. For example, “ [symbol] ”, “ [symbol] ”, “ [symbol] ” which is a final consonant, “ [symbol] ” in second word and “ [symbol] ” may be classified to three clusters, one cluster, one cluster, two clusters and two clusters, respectively. As a result, compression rate may be determined in the unit smaller than the phoneme.

Of course, the compression rate may be determined in a unit higher than the phoneme when a number of phonemes is greater than that of the clusters.

In an embodiment, every frame except the silence interval may be classified to the same number of clusters, and each of clusters is filled with sounds but is not vacant space.

In an embodiment, energy, pitch, delta-pitch, mel-spectrogram or variance of MFCC may be used as an input of the K-means clustering to perform the clustering classification. That is, 5-dimension vectors may be used to perform the clustering classification.

On the other hand, when designating the frame previously identified as silence interval as the 10th cluster, a total of ten clusters may be obtained. This clustering result is shown in FIG. 2.

Subsequently, the method of controlling the audio time stretching may determine speed of the clusters for each frame in a step of S104 and generate a speed script including information concerning clusters with the determined speed in a step of S106. For example, the method may generate the speed script including final 10 clusters to apply adaptive time stretching. This speed script may include cluster information for each frame and onset, offset and adaptive compression rate of corresponding cluster as shown in FIG. 3.

In an embodiment, the compression rate may be calculated based on dynamic time warping (DTW) of the cluster.

The DTW shown in following equation 3 is an algorithm for calculating similarity between two different dynamic signals. The smaller the value of the DTW, the more similar the two dynamic signals are considered to be. That is, the DTW has smaller value as pronunciation of the cluster before compression and pronunciation of the cluster after the compression are similar. In other words, the distortion is low when the DTW has small value. Accordingly, the higher compression rate is applied as the value of the DTW becomes smaller and the smaller compression is applied as the value of the DTW becomes greater, thereby minimizing the distortion.

$$DTW ( Q , P ) = \sqrt{dist ( {q}_{1} , {p}_{1} ) + min \{ \begin{matrix}Dif ( \{ {q}_{2} , … , {q}_{n} \} , \{ {p}_{2} , … , {p}_{m} \} ) \\ Diff ( \{ {q}_{2} , … , {q}_{n} \} , P ) \\ Diff ( Q , \{ {p}_{2} , … , {p}_{m} \} )\end{matrix}} \qquad [ Equation 3 ]$$

$$- X = Q ⋃ P$$

$$- Q = {q}_{1} , {q}_{2} , … , {q}_{n}$$

$$- P = {p}_{1} , {p}_{2} , … , {p}_{n}$$

$$- dist ( {q}_{1} , {p}_{1} ) = {\vert {q}_{1} - {p}_{1} \vert}^{2}$$

Here, Q means original wave data, P indicates a wave data generated by applying a specific speed to, e.g. PICOLA 2× speed, and dist (a, b) means squared Euclidean distance.

The similarity based on the DTW may be defined as shown in following Table 2.

TABLE 2

| | | | | |
|---|---|---|---|---|
| Normalized-DTW | 0~0.25 | 0.25~0.5 | 0.5~0.75 | 0.75~1 |
| Distortion degree | Extremely rare | Very little | A little | A lot |

In an embodiment, the method of controlling the audio time stretching may change every value of the DTW calculated for 10 clusters to a value between 0 and 1 by applying a min-max normalizing to the DTW, and determine compression rate (rate′) for each cluster based on normalized DTW as shown in following equation 4.

$${rate}^{′} = rate * {[ \frac{DTW ( Q , P )}{{E}_{\{ Q , P \} ∼ X} [ DTW ( Q , P ) ]} ]}^{- 1} * α \qquad [ Equation 4 ]$$

Here, rate′ means adaptive compression rate, rate indicates compression rate, and each of the rate′ and the rate is a value between 0 and 1. αas compression rate may be for example 0.8.

In a step of S108, the compression rate for each cluster is determined through aforementioned method, and the method of controlling the audio time stretching may playback audio based on a speed script with the determined compression rate. As a result, the method may realize smoothly high speed without distortion.

Consequently, the silence interval has highest compression rate, and a cluster with greatest DTW has lowest compression rate.

Briefly, the method of controlling the audio time stretching of the present embodiment may detect the silence interval of the inputted audio, classify the frames except the silence interval to a preset number of clusters, determine the compression rate for each cluster and playback the audio based on the determined compression rate. Especially, the method determines the compression rate based on the DTW reflecting pronunciation feature, thereby minimizing the distortion during playback. In this case, the silence interval may have highest compression rate, and the cluster with greatest DTW may have lowest compression rate.

Every frame has the same number of clusters in above description, but the number of clusters may differ depending on the frame. For example, the number of cluster for a frame including most number of phonemes may be higher than that of cluster for a frame including least number of phonemes. In another example, the number of cluster including most number of nasal sound or fricative sound may higher than that of cluster including least number of nasal sound or fricative sound.

In another embodiment, the clustering is performed in a unit of one frame in above description, but it may be performed in a unit of plural frames. For example, two frames may be classified to nine clusters. However, the number of clusters may differ according to location of two frames, etc.

In still another embodiment, the compression rate is determined for each cluster in above description, but it may be determined for plural clusters. For example, the compression rate may be determined in a unit of adjacent two clusters.

In still another embodiment, the frame may be clustered such that every cluster includes the same number of phonemes, and the compression rate may be determined for each cluster. This method will be applied only when the number of phonemes is higher than that of clusters.

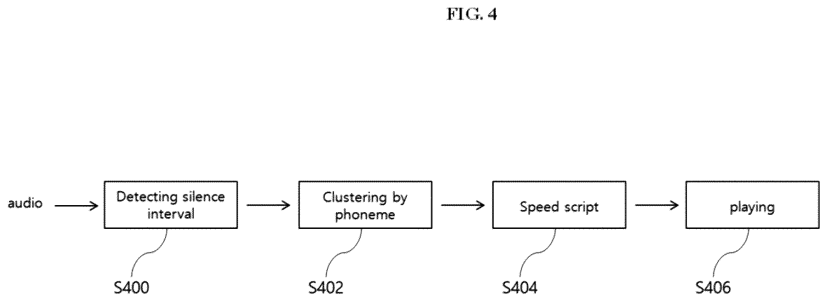

FIG. 4 is a view illustrating a process of controlling audio time stretching according to another embodiment of the disclosure.

In FIG. 4, the method of controlling the audio time stretching of the present embodiment may detect a silence interval from the inputted audio in a step of S400 and cluster phonemes in every frame except the detected silence interval in a step of S402.

In an embodiment, the method may classify phonemes with severe distortion and phonemes with a little distortion to different clusters. For example, nasal sound or fricative sound and plosive sound may be classified to different clusters. For another example, the nasal sound and the fricative sound may be classified to different clusters.

Here, the same phoneme may belong always to the same cluster, and the same compression rate may be applied to the same cluster. Of course, different compression rate may be applied to each frame even when the frames belong to the same cluster. The compression rate may be determined based on the DTW reflecting pronunciation feature. Any further description concerning the determining of the compression rate will be omitted because the determining is described in detail in above description.

In another embodiment, the same phoneme may be classified to different cluster depending on position. That is, even if phonemes are identical, they may be assigned to different clusters depending on their position within a word. For example, a phoneme appearing at the initial position of a word may be assigned to a different cluster from the same phoneme appearing in a non-initial position. For another example, a phoneme in the final position of a syllable may be assigned to a different cluster from the same phoneme in a non-final position.

Subsequently, the method of controlling the audio time stretching may generate a speed script by determining the compression rate for each cluster in a step of S404, and playback the audio according to the speed script in a step of S406.

Shortly, the method of controlling the audio time stretching of the present embodiment may perform the clustering based on a phoneme, determine the compression rate depending on the cluster and playback the audio with the determined compression rate.

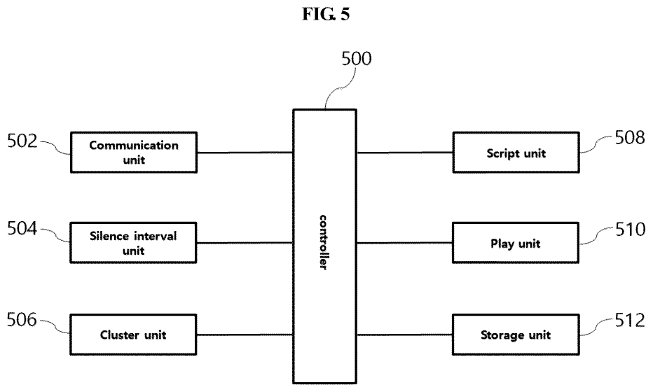

FIG. 5 is a block diagram illustrating a device of controlling audio time stretching according to an embodiment of the disclosure.

In FIG. 5, the device of controlling the audio time stretching of the present embodiment may include a controller 500, a communication unit 502, a silence interval unit 504, a cluster unit 506, a script unit 508, a play unit 510 and a storage unit 512.

The communication unit 502 is a communication path with an external device and may receive the audio.

The silence interval unit 504 detects the silence interval in inputted audio.

The cluster unit 506 may cluster every frame except the silence interval of the inputted audio. Here, the silence interval may be also classified as a cluster.

The script unit 508 may determine the compression rate for each cluster based on for example the DTW and generate the speed script with the determined compression rate.

The play unit 510 may playback the audio according to the generated speed script.

The storage unit 512 may store various information such as the speed script and so on

The controller 500 may control operation of elements in the device of controlling the audio time stretching.

Components in the embodiments described above can be easily understood from the perspective of processes. That is, each component can also be understood as an individual process. Likewise, processes in the embodiments described above can be easily understood from the perspective of components.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the disclosure or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the disclosure, and vice versa.

The embodiments of the disclosure described above are disclosed only for illustrative purposes. A person having ordinary skill in the art would be able to make various modifications, alterations, and additions without departing from the spirit and scope of the disclosure, but it is to be appreciated that such modifications, alterations, and additions are encompassed by the scope of claims set forth below.

1. A device for controlling audio time stretching comprising:
a silence interval unit configured to detect a silence interval of an audio;
a cluster unit configured to classify at least one of frames except the detected silence interval of the audio to plural clusters; and
a script unit configured to set compression rate to the clusters and generate a speed script including information concerning the clusters with the set compression rate,
wherein one or more of the clusters have different compression rate from another cluster.

2. The device of claim 1, further comprising:
a play unit configured to playback the audio according to the generated speed script,
wherein every frame except the silence interval is classified to the clusters, the compression rate is set to each cluster, every frame has the same number of clusters, and every cluster is filled with sound.

3. The device of claim 1, wherein one phoneme is dividedly assigned to the clusters.

4. The device of claim 1, wherein compression rate of the silence interval is higher than that of the cluster for the frame.

5. The device of claim 1, wherein the silence interval is detected based on energy of speech feature of the audio.

6. The device of claim 1, wherein the compression rate is determined by using dynamic time warping (DTW), shown in following DTW equation, for calculating similarity of pronunciation of the cluster before compression and pronunciation of the cluster after the compression,
and wherein the higher the value of the DTW, the smaller the compression rate,
$$DTW ( Q , P ) = \sqrt{dist ( {q}_{1} , {p}_{1} ) + min \{ \begin{matrix}Dif ( \{ {q}_{2} , … , {q}_{n} \} , \{ {p}_{2} , … , {p}_{m} \} ) \\ Diff ( \{ {q}_{2} , … , {q}_{n} \} , P ) \\ Diff ( Q , \{ {p}_{2} , … , {p}_{m} \} )\end{matrix}} \qquad [ DTW equation ]$$
$$- X = Q ⋃ P$$
$$- Q = {q}_{1} , {q}_{2} , … , {q}_{n}$$
$$- P = {p}_{1} , {p}_{2} , … , p$$
$$- dist ( {q}_{1} , {p}_{1} ) = {\vert {q}_{1} - {p}_{1} \vert}^{2}$$
here, Q means original wave data, P indicates a wave data generated by applying a preset speed to Q, and dist (a, b) means squared Euclidean distance.

7. The device of claim 1, wherein the same sound is assigned to different cluster depending on the frame, and different compression rate is applied to the same sound.

8. A device for controlling audio time stretching comprising:
a silence interval unit configured to detect a silence interval of an audio;
a cluster unit configured to classify phonemes in frames except the detected silence interval of the audio to plural clusters; and
a script unit configured to set compression rate to the clusters and generate a speed script including information concerning the clusters with the set compression rate,
wherein one or more of the clusters have different compression rate from another cluster, and nasal sound or fricative sound and plosive sound are assigned to different cluster.

9. The device of claim 8, wherein the clustering is performed in a unit of a frame,
and wherein compression rate of a cluster to which the nasal sound or the fricative sound belongs is smaller than that of a cluster to which the plosive sound belongs.

10. The device of claim 8, wherein the same phoneme belongs to the same cluster irrespective of the frame.

11. The device of claim 8, wherein the same phoneme belongs to different cluster according to position of the phoneme.

12. A method of controlling audio time stretching, the method comprising:
detecting a silence interval from inputted audio;
classifying frames except the detected silence interval of the inputted audio to plural clusters;
setting compression rate to each cluster;
generating a speed script including information concerning the clusters with the set compression rate; and
playing back the audio according to the generated speed script,
wherein at least one of the clusters has different compression rate from another cluster.

13. The method of claim 12, wherein speech belonging to at least one of the clusters is pronunciation in a unit smaller than phoneme.
